(19) United States
(12) Patent Application Publication
(10) Pub. No.: US 2002/0124947 A1
(43) Pub. Date: Sep. 12, 2002

(54) Sterilized adhesive sheet stack for securing and sterilizing articles

(76) Inventor: Steven Kim, Harrington Park, NJ (US)

Correspondence Address: MORGAN LEWIS & BOCKIUS LLP, 1111 PENNSYLVANIA AVENUE NW, WASHINGTON, DC, 20004, US

(21) Appl. No.: 09/801,796

(22) Filed: Mar. 9, 2001

(51) Int. Cl. C09J 1/00

(52) U.S. Cl. 156/247; 156/289

(57) ABSTRACT

A flexible, heat and water-resistant adhesive sterilized sheet, having a top and bottom surfaces, and a pressure sensitive sterilized adhesive film on at least one of the surfaces of the sheet. Furthermore, the adhesive sterilized sheet is stacked and fitted in a container wherein various articles are placed and fixed on the top surface of the sheets.

### BACKGROUND OF THE INVENTION

1. Field of the Invention

The present invention relates to adhesive sheet pads, and in particular it relates to sterilized adhesive sheet pads packaged in a container that allows securing medical tools to the surface of the adhesive sheet, and sterilizing the surface of the medical tool in contact with the adhesive sheet. Additionally, the sterilized adhesive sheet pad allows the packaging of medical samples or specimens.

2. Discussion of the Related Art

Many medical procedures require a specific group of medical tools. The tools must be sterilized and presented at the site in a manner facilitating quick selection and retrieval of a needed tool by the medical practitioner during the medical procedure.

Container systems have been developed in the past, which organize, sterilize, store and present a specific group of tools for surgical procedures. In this regard, it is normally intended that the surgical tool container system organize a group of tools in a manner allowing the medical practitioner to retrieve the needed tools directly from the container during the medical procedure Unfortunately, these as well as other prior container systems have given little attention to at least two very important considerations. First, securing the tools in the container in a manner that substantially prevents the accidental dislodgment of the tools from their original place within the container regardless of container orientation or movement. Second the ease by which a medical practitioner can select and then remove the needed tool from a group of tools within the container during surgical procedure.

Regarding the first consideration, during handling the container is many times inverted from its correct orientation, potentially disturbing the organization of the tools within the container. Should this occur, valuable time is spent on reorganizing the tools within the container prior to the medical procedure, and without the need for re-sterilization should some of the tools fall entirely out of the container. The container thus preferably includes means to securely retain the tools in their organized position within the container, regardless of the orientation of the container.

Regarding the second consideration, the medical practitioner needs to be able to select and remove the needed tool from the container fairly quickly and easily, and advantageously with the use of a single hand. While the container must be durable and include features to securely retain the tools in their position, those features must not conflict with the need for quick identification and retrieval of a tool from the container. Also, once the medical procedure is finished, the tools must be replaced in their original positions within the container. Thus, it is furthermore desirable that the features, which permit secure retention of the tools within the container also, permit quick and easy replacement, of those same tools back in their original positions in the container.

### SUMMARY OF THE INVENTION

Accordingly, the present invention is drawn to a stack or pad of sterilized adhesive sheets used in a medical or surgical tool container. The pad of sterilized adhesive sheets, organizes, presents a specific group of tools for a medical procedure, and prevents the accidental dislodgment of the tools from their original place. Furthermore, the sterilized adhesive sheet sterilizes the tool that contacts the sheet. Additionally, the pad prevents the accidental dislodgment of the tools from the container in the event of an abrupt movement of the container. The sterilized adhesive pad further includes novel features designed to wrap up medical samples or specimens in a sterilized environment using the adhesive and flexible nature of the sheets that form the pad.

Additional features and advantageous of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the invention, as embodied and broadly described, the present invention provides an adhesive sterilized sheet for sterilizing articles. The adhesive sterilized sheet including top and bottom surfaces, and a pressure sensitive sterilized adhesive film on at least one of the surfaces of the sheet, wherein the articles are placed and fixed on the top surface.

Additionally, the invention provides a stack of adhesive sterilized sheets for sterilizing articles. The stack includes a plurality of sterilized sheets, each sheet comprising a top surface and a bottom surface, a pressure sensitive sterilized adhesive film on at least one of the surfaces of each sheet. Furthermore, the invention provides a container enclosing the stack of adhesive sterilized sheets, wherein the articles are placed and fixed on the top surface.

Another object of the invention is to provide a method for securing and sterilizing comprising the steps of securing a stack of adhesive sheets in a container, wherein each adhesive sheet comprises a top surface, a bottom surface, placing at least one article on the adhesive sheets, and a pressure sensitive sterilized adhesive film on the top surface.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute part of this specification, illustrate embodiments of the invention and together with the description serve to explain the principles of the invention.

In the drawings:

FIG. 1 is a perspective view of a stack of sterilized adhesive sheets in the present invention;

FIG. 2 is a cross-sectional view of a single sterilized adhesive sheet in the present invention;

FIG. 3 shows a tool tray containing a stack of sterilized adhesive sheets, and medical tools placed over the adhesive sheets in the present invention;

FIG. 4 shows a medical sample wrapped in a sterilized adhesive sheet in the present invention.

### DETAILED DESCRPTION OF THE PREFERRED EMBODIMENTS

Reference will not be made in detail to the preferred embodiments of the present invention, examples of which are illustrated in the accompanying drawings. Wherever possible, the same reference numbers will be used throughout the drawing to refer to the same or like parts.

The present invention provides a stack of sterilized adhesive sheets attached to the bottom of a medical or surgical tool tray. The medical or surgical tools are stuck to the pad so that the tools are not scattered around in the event the tray is moved abruptly. Furthermore, each new sterilized sheet can be used after detaching the top sheet.

Additionally, the sterilized adhesive sheet can be used to wrap-up a medical sample or specimen.

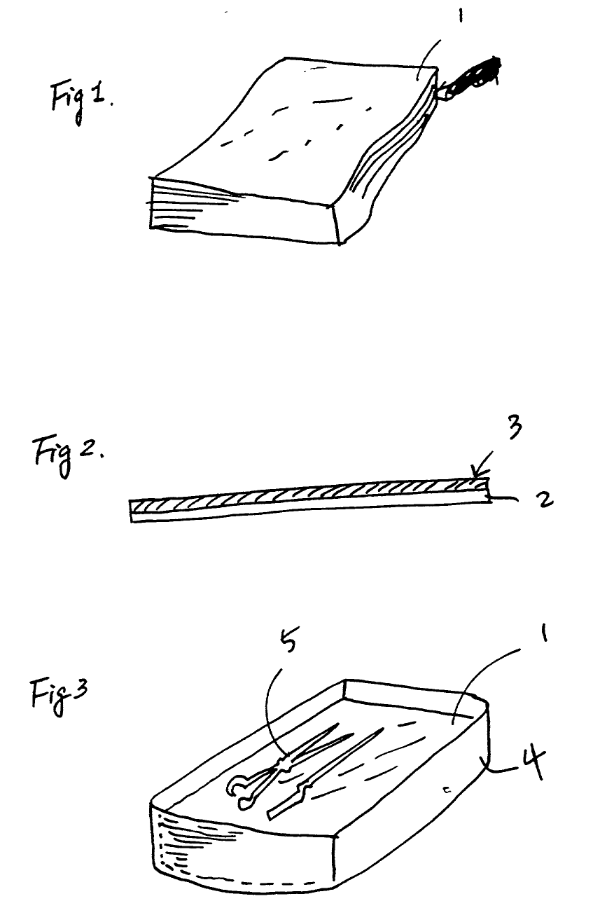

FIG. 1 shows a perspective view of a stack of sterilized adhesive sheets 1. The adhesive sheets are substantially the same size and are stacked one on top of the other. After one of the sheets has been used, the sheet is removed from the stack and discarded. This allows a new sterilized sheet to appear at the top of the stack.

FIG. 2 shows a cross-sectional view of a single adhesive sheet. The adhesive sheet comprises a bottom surface 2 and a top surface 3. The bottom surface 2 has coated on one surface thereof a self-adhesive or pressure-sensitive sterilized adhesive film 3. The adhesive utilized in the adhesive sheet is prepared according to standard industry procedures. The sterilized adhesive sheet can have a variety of configurations so as to be fitted in containers of different shape. Furthermore, the sheet is flexible so as to permit the sheet to be wrapped around any item. Additionally, the sheet is elastic in character, water and heat resistant.

FIG. 3 shows a medical tray 4 in which a stack of sterilized adhesive sheets 1 are positioned. The self-adhesive is sufficiently strong to hold an article in place, but not too strong that would prevent the individual from easily removing the article from the container. A variety of medical tools 5 are placed on the stack of sterilized adhesive sheets 1. Once the sterilized adhesive sheet has been used, it is separated from the stack and discarded. This permits a newly sterilized adhesive sheet to appear at the top of the stack.

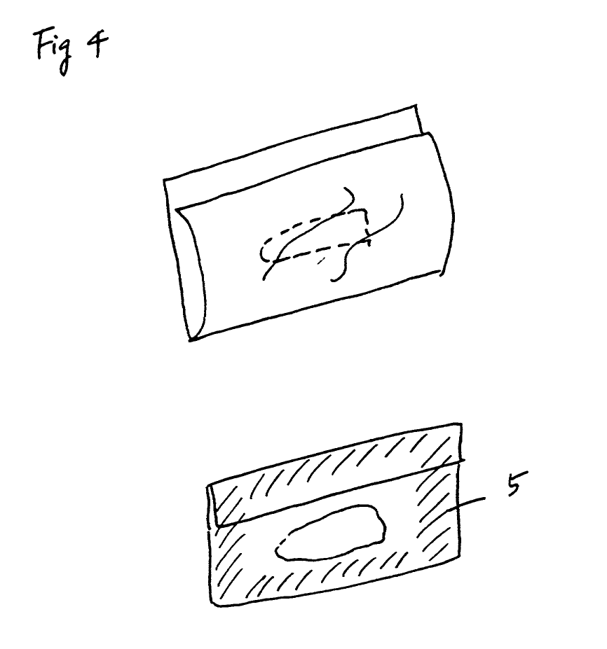

FIG. 4 shows a second embodiment for using the sterilized adhesive sheets. A medical specimen 6 or sample is placed on a sterilized adhesive sheet and wrapped. Because of the nature of the adhesive sheet, the medical sample can be held tightly within an adhesive sheet.

While the invention has been described in detail and with reference to specific embodiments thereof, it will be apparent to one skilled in the art that various changes and modifications can be made therein without departing from the spirit or scope thereof. Thus, it is intended that the present invention covers the modifications and variations of this invention provided they come within the scope of the appended claims and their equivalents.

What is claimed is:

1. An adhesive sterilized sheet for securing and sterilizing articles comprising:
top and bottom surfaces; and
a pressure sensitive sterilized adhesive film on at least one of the surfaces of the sheet, wherein the articles are placed and fixed on the top surface.

2. The sheet of claim 1, wherein the sheet is disposable.

3. The sheet of claim 1, wherein the sheet is water resistant.

4. The sheet of claim 1, wherein the sheet is flexible.

5. The sheet of claim 1, wherein the sheet is heat resistant.

6. A stack of adhesive sterilized sheets for securing and sterilizing articles comprising:
a plurality of sterilized sheets, each sheet comprising a top surface and a bottom surface;
a pressure sensitive sterilized adhesive film on at least one of the surfaces of each sheet;
a container, enclosing the stack of adhesive sterilized sheets, wherein the articles are placed and fixed on the top surface.

7. The sheets of claim 6, wherein each sheet is disposable.

8. The sheets of claim 6, wherein each sheet is water resistant.

9. The sheet of claim 6, wherein each sheet is flexible.

10. The sheet of claim 6, wherein each sheet is heat resistant.

11. A method for securing and sterilizing articles comprising the steps of:
securing a stack of adhesive sheets in a container, wherein each adhesive sheet comprises a top surface, a bottom surface, and a pressure sensitive sterilized adhesive film on the top surface;
placing at least one article on the adhesive sheets;
detaching the article from the adhesive sheet to be used in intended purposes; and
discarding the exposed adhesive sheet from the stack.

12. The method of claim 11, further comprising the step of placing an item on the adhesive sheet and wrapping the item in the adhesive sheet.

13. The method of claim 11, further comprising the step of repeating the steps of placing at least one article on the adhesive sheet;
detaching the article from the adhesive sheet to be used in intended purpose, and
discarding the exposed adhesive sheet from the stack.
